(19) United States
(12) Patent Application Publication
(10) Pub. No.: US 2011/0153891 A1
(43) Pub. Date: Jun. 23, 2011

(54) COMMUNICATION APPARATUS AND COMMUNICATION CONTROL METHOD

(76) Inventors: Akihiro Ebina, Kyoto (JP); Seiji Kubo, Osaka (JP)

(21) Appl. No.: 13/059,679

(22) PCT Filed: Aug. 18, 2009
(86) PCT No.: PCT/JP2009/003923

§ 371 Date: Feb. 18, 2011

(30) Foreign Application Priority Data
Aug. 20, 2008 (JP) 2008-211542

(51) Int. Cl. G06F 13/00

(52) U.S. Cl. 710/110

(57) ABSTRACT

A communication apparatus including a master device (200) and a slave device (300) is provided. The slave device (300) includes: a slave control unit (302) which controls the slave device (300); a relay register (301) in which data is written according to a control signal; a data communication unit (304) which establishes a connection with an external data communication channel; and a slave storage unit (303) which stores a control program controlling an operation of the data communication unit (304). The slave control unit (302) controls the data communication unit (304) by (i) obtaining information corresponding to control, (ii) reading from the slave storage unit (303) a control program which is associated with the obtained information corresponding to control, and (iii) executing the read control program, the information corresponding to control being information on the writing of the data in the relay register (301) according to the control signal.

### TECHNICAL FIELD

The present invention relates to a communication apparatus including a master device and a slave device which achieve communication using a communication protocol defined by a predetermined standard, and a communication method.

### BACKGROUND ART

There are communication apparatuses using Management Data Input/Output (MDIO) interfaces specified by IEEE802.3. Those apparatuses access resisters of physical layer (PHY) devices via MDIO master devices to read and write desired address information.

Such a communication apparatus equipped with the MDIO interfaces employs an error detecting technique.

Specifically, the technique involves inserting a lower bit into the second bit of a turn around included in a TM2002-compliant frame used for an MDIO interface. The lower bit is obtained as a result of performing a checksum on data of a resister of a slave device to be read. Furthermore, the technique compares the lower bit with a value obtained through a checksum of return data performed by a master device to detect an error when the master device is performing transmission and reception of data (See Patent Literature).

In addition, there are communication modules having a bridge capability, converting data between a wired PHY device and a wireless PHY device.

Such a communication module causes a central processing unit (CPU) included therein to execute a control program of the wired PHY device or the wireless PHY device.

### CITATION LIST

### Patent Literature

Japanese Unexamined Patent Application Publication No. 2008-118349

### SUMMARY OF INVENTION

### Technical Problem

When a PHY device of a communication apparatus including a CPU is replaced with the CPU-equipped communication module described above, the communication apparatus recognizes the communication module as an independent device. Accordingly, a parameter configuration of the communication module needs to be changed.

The conventional communication module, however, causes the CPU included therein to execute the control program to run the wireless PHY device included in the communication module. Thus, unfortunately, the CPU built in the communication apparatus cannot control the communication module.

In addition, the control program stored in the conventional communication apparatus is designed to access an IEEE802.3-compliant PHY device. Hence when the conventional communication apparatus is equipped with a communication module having a built-in CPU, the communication apparatus has to have a control unit designated to the communication module. This requires a further change in the control program.

The present invention is conceived in view of the above problems and has as an object to introduce a communication apparatus causing a master control unit positioned higher than a communication module to control a PHY device of the communication module including a control unit, and a communication control method thereof.

### Solution to Problem

A communication apparatus according to an aspect of the present invention includes a master device and a slave device which receives a control signal provided from the master device, wherein the slave device includes: a slave control unit which controls the slave device; a relay register in which data is written according to the control signal; a data communication unit which establishes a connection with an external data communication channel; and a slave storage unit which stores a control program controlling an operation of the data communication unit, and the slave control unit controls the data communication unit by (i) obtaining information corresponding to control, (ii) reading from the slave storage unit a control program which is associated with the obtained information corresponding to control, and (iii) executing the read control program, the information corresponding to control being information on the writing of the data in the relay register according to the control signal.

The above structure allows the master device to control the slave device. Specifically, the master device can employ an access sequence similar to that used for a conventional PHY device so as to control a PHY device; namely the data communication unit, included in the slave device.

Hence, when a conventional master device is used for the communication apparatus in the present invention, a program executed on the master device does not require many changes. Accordingly, the present invention makes possible curbing an increase in costs for developing the program and reducing malfunctions in the program.

Hardware-wise, specifically, the master device requires no designated control unit used for controlling the data communication unit. Software-wise, an existing program for the master device does not require many changes. As a result, the present invention contributes to a curb on an increase in costs for developing the program and reduction in malfunctions in the program.

The master device may include: a master control unit which controls the master device; and a master storage unit which stores a control program controlling the master device, when detecting a condition change of the data communication unit, the slave control unit may write data in the relay register depending on details of the detected condition change, and the master control unit may control the master device by (i) obtaining information corresponding to a change, (ii) reading from the master storage unit a control program which is associated with the obtained information corresponding to a change, and (iii) executing the read control program, the information corresponding to a change being information on the writing of the data in the relay register of the data by the slave control unit.

When a condition change, such as linking-up and linking-down, is found in the data communication unit, this structure allows the master device to execute control depending on the change. In other words, consistency is ensured in operations of the slave device and the master device even in the case where a condition change occurs in the data communication unit.

The master device and the slave device may be connected via an IEEE 802.3-defined Management Data Input/Output (MDIO) interface.

This structure allows the master device to control the PHY device included in the slave device via the MDIO interface, employing an access sequence similar to that used for a conventional PHY device.

The slave control unit may (i) obtain a change address as the information corresponding to control, the change address being an address included in the relay register in which the data is written according to the control signal, (ii) read the control program associated with the change address from the slave storage unit, and (iii) execute the read control program.

According to the structure, the slave control unit simply detects the change address included in the relay register in order to execute a process in response to a request from the master device.

The slave control unit may obtain the change address by (i) reading the data stored in the relay register twice at a predetermined interval, and, in the case where a difference is found between the twice-read data, (ii) specifying an address corresponding to the difference as the change address.

Even though the relay register is not capable of notifying the slave control unit, using an interrupt signal, of writing in the relay register, the structure allows the slave control unit to detect the change address.

The slave control unit may read the data twice only from a designated area included in the relay register.

This structure contributes to less access frequency to the relay register, leading to a less processing load imposed on the slave control unit.

The present invention is also achieved as a method for controlling communication which involves processes of processing units included in the communication apparatus according to an implementation of the present invention.

A broadcast receiving apparatus according to an implementation of the present invention is capable of establishing a connection with a network. The broadcast receiving apparatus includes the following: the communication apparatus according to the implementation of the present invention, an image processing unit which decodes image data obtained from the communication apparatus, and a displaying unit which display the decoded image data obtained from the image processing unit.

A reproducing apparatus according to an implementation of the present invention is capable of establishing a connection with a network. The reproducing apparatus includes the following: the communication apparatus according to the implementation of the present invention, a reproducing unit which decodes image data obtained from the communication apparatus, and an outputting unit which outputs the decoded image data obtained from the reproducing unit.

As described above, the present invention can be widely employed for a network-connectable audio-visual appliance including a TV, a Digital Versatile Disk (DVD) recorder, and a Blu-ray Disc (BD) recorder.

### Advantageous Effects of Invention

The present invention allows a master device to control a slave device including its own control unit. Specifically, the master device can control a PHY device included in the slave device, so can control a conventional PHY device included in the slave device. As a result, for example, a control program to be executed by the communication apparatus does not require much change. This makes possible curbing an increase in costs for developing the control program and reducing malfunctions in the control program.

### BRIEF DESCRIPTION OF DRAWINGS

FIG. 1 is a schematic block diagram of a television according to an embodiment in the present invention.

FIG. 2 is a block diagram of major constituent features included in a communication apparatus according to the embodiment in the present invention.

FIG. 3 exemplifies a table showing a list of all addresses included in a relay resister according to the embodiment in the present invention.

FIG. 4 is a flowchart showing a processing flow when a CPU included in a master device controls a wireless PHY device according to the embodiment in the present invention.

FIG. 5 is a flowchart showing a processing flow when the CPU included in the master device controls the wireless PHY device depending on a status change of the wireless PHY device according to the embodiment in the present invention.

FIG. 6 is a block diagram of major constituent features included in a communication apparatus of Modification according to the embodiment in the present invention.

FIG. 7 is a schematic block diagram of a reproducing apparatus exemplifying an audio-visual appliance including the communication apparatus according to the embodiment in the present invention.

### DESCRIPTION OF EMBODIMENT

### Embodiment

Described below is an embodiment in the present invention with reference to the drawings.

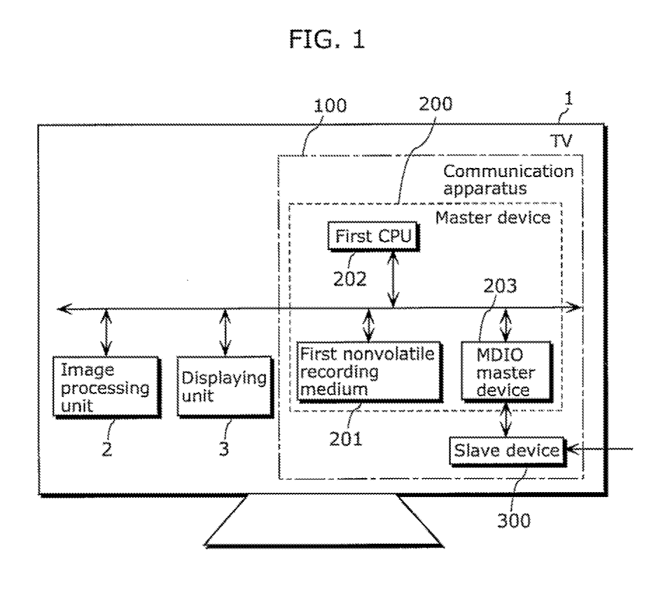

FIG. 1 is a schematic block diagram of a television 1 (hereinafter referred to as “TV 1”) exemplifying an audio-visual appliance including a communication apparatus 100 according to the embodiment in the present invention.

The TV 1 according to the embodiment exemplifies a broadcast receiving apparatus in the present invention.

As shown in FIG. 1, the TV 1 includes the following as major constituent features: an image processing unit 2, a displaying unit 3, and the communication apparatus 100. The image processing unit 2 and the displaying unit 3 are connected to a first CPU 202 included in a master device 200. The master device is included in the communication apparatus 100.

The communication apparatus 100 includes the master device 200 and a slave device 300.

The master device 200 includes the first CPU 202, a first nonvolatile recording medium 201, and an MDIO master device 203.

The slave device 300 is connected to the MDIO master device 203 via an MDIO interface bus 101. The slave device 300 is also connected to an external network.

Exemplifying a master control unit of the communication apparatus in present invention, the first CPU 202 a control unit controlling an operation of the master device 200.

It is noted that, in FIG. 1, a CPU controlling an entire operation of the TV 1 is not shown. Here, the first CPU 202 may work as a control unit controlling the entire operation of the TV 1 including the image processing unit 2 and the displaying unit 3.

The image processing unit 2 decodes image data downloaded from airwaves and a network, and causes the displaying unit 3 to display the decoded image data. The displaying unit 3 displays an image. Employed as the displaying unit 3 is the following: a liquid crystal display (LCD), a plasma display panel (PDP), and an organic electro-luminescence (OEL).

The TV 1 decodes on the image processing unit 2 airwaves received with an antenna (not shown), and displays the decoded airwaves on the displaying unit 3. The TV 1 also sets up a wired or wireless connection between the slave device 300 and an access point to get connected to the external network.

This structure makes possible decoding on the image processing unit 2 image data downloaded from the Internet via the external network, and displaying the decoded image data on the displaying unit 3.

Described below is the communication apparatus 100 in an aspect of the present invention with reference to the drawings.

Described first is a structure of the communication apparatus 100 with reference to the drawing.

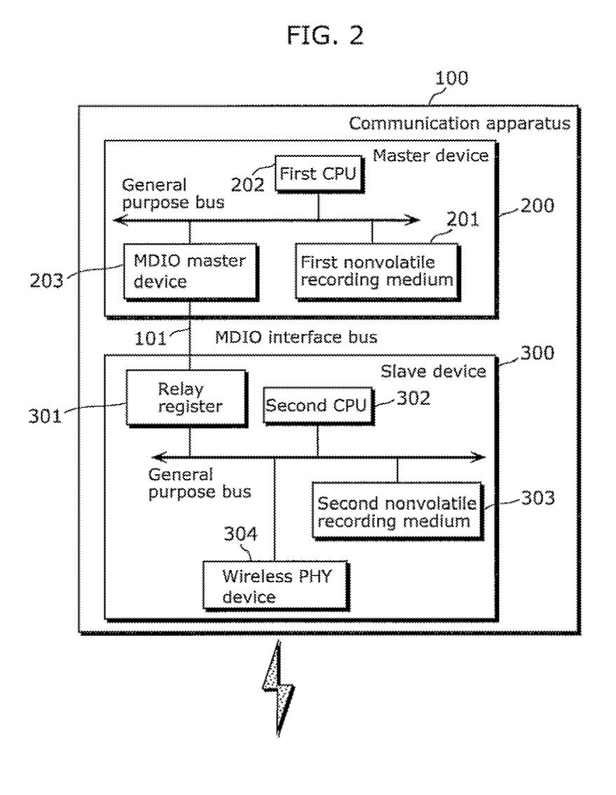

FIG. 2 shows major constituent features included in the communication apparatus 100 according to the embodiment.

As described above, the communication apparatus 100 includes the master device 200 and the slave device 300.

The master device 200 is connected to the slave device 300 via the MDIO interface bus 101. The MDIO interface bus 101 is compliant with an MDIO communication standard specified by IEEE802.3.

The master device 200 also controls the slave device 300 to exercise a control over the entire operation of the communication apparatus 100. In addition, each of the master device 200 and the slave device 300 has an independent CPU.

The master device 200 includes the first nonvolatile recording medium 201, the first CPU 202, and the MDIO master device 203.

Exemplifying a master accumulating unit of the communication apparatus in the present invention, the first nonvolatile recording medium 201 stores two or more control programs used for controlling an operation of the MDIO master device 203.

These control programs include a program which the MDIO master device 203 operates on for reading and writing data stored in a relay resister 301.

As far as the first CPU 202 executes processes based on an after-described change address, those processes may be carried out on a single control program. In other words, the first nonvolatile recording medium 201 may store a single control program instead of the two or more control programs.

Any storage medium can be the first nonvolatile recording medium 201 as far as the storage medium is capable of storing information, such as a hard disk drive (HDD) and a flash memory device including an electrically erasable/programmable read-only memory (EEPROM).

The first CPU 202 is capable of reading the control programs stored in the first nonvolatile recording medium 201 via a general purpose bus, and executing the read control programs.

The first CPU 202 can be made of a semiconductor device. The first CPU 202 can be formed either only of hardware or of a combination of hardware and software.

It is noted that the embodiment in the present invention has described that the first nonvolatile recording medium 201 is independent from the first CPU 202. However, the first nonvolatile recording medium 201 may be included in the first CPU 202.

Here, when the first CPU 202 reads to execute the control programs, the first CPU 202 does not have to rely on the general purpose bus for the reading. This structure contributes to a shorter processing time.

The MDIO master device 203 is controlled by the first CPU 202. In compliance with MDIO specifications, the MDIO master device 203 is capable of reading and writing the data via the MDIO interface bus 101, the data which is stored in the relay resister 301.

The slave device 300 includes the following: the relay resister 301, a second CPU 302, a second nonvolatile storage medium 303, and a wireless PHY device 304.

Each of the constituent features is connected through a general purpose bus. It is noted that any bus can be used as the general purpose bus as far as the bus is used for hardware.

The relay resister 301 is connected to the MDIO master device 203 via the MDIO interface bus 101, and works as a slave of the MDIO master device 203.

The relay resister 301 receives and provides data from and to both the first CPU 202 and the second CPU 302. When the first CPU 202 writes the data in the relay resister 301, the relay resister 301 provides an interrupt acknowledgement to the second CPU 302.

Exemplifying a slave accumulating unit of the communication apparatus in the present invention, the second nonvolatile storage medium 303 stores two or more control programs used for controlling an operation of the wireless PHY device 304.

The first nonvolatile recording medium 303 can be any storage medium capable of storing information, such as a hard disk drive (HDD) and a flash memory device including an electrically erasable/programmable read-only memory (EEPROM).

As far as the first CPU 202 executes processes based on the after-described change address, those processes may be carried out on a single control program. In other words, the first nonvolatile recording medium 303 may store the single control program instead of two or more control programs.

Exemplifying a slave control unit of the communication apparatus in present invention, the second CPU 302 is a control unit controlling the slave device 300.

Via the general purpose bus, the second CPU 302 reads to execute the control programs stored in the second nonvolatile storage medium 303 so as to control an operation of the wireless PHY device 304.

The second CPU 302 executes a process (hereinafter referred to as a first obtaining process) which involves obtaining information. Here, the information is on writing of data in the relay resister 301 by the first CPU 202 included in the master device 200.

The first CPU 202 executes a process (hereinafter referred to as a second obtaining process) which involves obtaining information. Here, the information is on writing of data in the relay resister 301 by the second CPU 302 included in the slave device 300.

It is noted that the embodiment in the present invention has described that the second nonvolatile storage medium 303 includes the second CPU 302 and independent devices. However, the second nonvolatile storage medium 303 may be included in the second CPU 302.

Here, when the second CPU 302 reads to execute the control programs, the second CPU 302 does not have to rely on the general purpose bus for the reading. This structure contributes to a shorter processing time.

Controlled by the second CPU 302, the wireless PHY device 304 uses a communication standard specified by IEEE801.11 and IEEE802.15.1 to communicate with an external apparatus via the wireless network.

The wireless PHY device 304 includes the following: the PHY representing Layer 1 of the Open Systems Interconnection (OSI) model, the Media Access Control (MAC), and a register which stores data indicating a configuration and a condition of the wireless PHY device 304.

The wireless PHY device 304 has transmission and reception capabilities. The transmission capability involves converting digital data into an electric signal, and transmitting the electric signal to the wireless network. The reception capability involves converting an electric signal flowing through the wireless network into digital data, and receiving the digital data.

In addition, the wireless PHY device 304 is capable of providing an interrupt acknowledgement to the second CPU 302 in the case where a condition of the wireless PHY device 304 has changed.

Here, the condition change of the wireless PHY device 304 means a change in a current condition of the device. The condition change indicates the following: a field intensity change found in the wireless PHY device 304, and a connecting condition change such as linking-up to and linking-down from the external apparatus.

For example, when a network, including the external apparatus and a wireless local access network (LAN), is shut down, the wireless PHY device 304 provides to the second CPU 302 the interrupt acknowledgement indicating a condition with no connection established.

Detailed below is an example of the first obtaining process executed by the second CPU 302.

Described first is timing of the second CPU 302 executing the first obtaining process.

When the relay resister 301 provides an interrupt acknowledgement to the second CPU 302, the second CPU 302 carries out first detection.

Described next is the first obtaining process in detail.

First, the first CPU 202 writes data in the relay resister 301. Upon receiving the data, the relay resister 301 provides an interrupt acknowledgement to the second CPU 302.

It is noted that the relay resister 301 includes hardware (hereinafter referred to as a resister managing unit. Not shown in the drawings including FIG. 2) managing writing and reading of the data. Technically, the resister managing unit provides the interrupt acknowledgement to the second CPU 302. The Description states, however, “the relay resister 301 provides the interrupt acknowledgement” for the sake of clarifying the details of the aspect of the present invention. The same goes for the processes other than interrupt acknowledgement.

Upon receiving the interrupt acknowledgement from the relay resister 301, the second CPU 302 obtains from the relay register 301 an address in which the first CPU 202 writes the data.

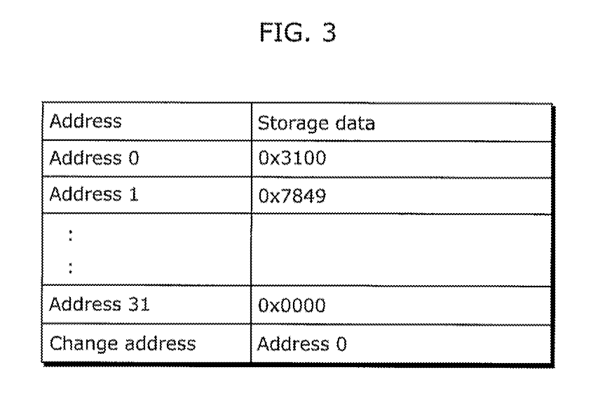

With reference to FIG. 3, specifically described is how to obtain the address.

FIG. 3 exemplifies a table showing a list of all addresses included in the relay resister 301.

It is noted that the table is updated by the resister managing unit.

Upon receiving the interrupt acknowledgement from the relay resister 301, the second CPU 302 reads data associated with a change address from the table included in the relay resister 301. Through the process, the second CPU 302 obtains the change address included in the relay resister 301 and representing an address in which the first CPU 202 writes the data.

FIG. 3 shows stored data associated with a change address. The stored data indicates Address 0. Here the second CPU 302 obtains, for example, “0” as the change address representing the address in which the first CPU 202 has written the data.

It is noted that the information obtained by the second CPU 302 shall not be limited to a change address included in the relay resister 301; instead, the information may be storage data associated with the change address.

Hence, the change address or the storage data associated with the change address, both obtained by the second CPU 302, exemplifies information corresponding to control used for the communication apparatus in the present invention. The second CPU 302 reads from the second nonvolatile storage medium 303 a control program which is associated either with the obtained change address or the obtained storage data, and executes the read control program.

It is noted that the control program which is executed by the second CPU 302 for obtaining the change address or the storage data may also carry out control corresponding to the storage data. Here, when the second CPU 302 reads to execute the corresponding control, the second CPU 302 does not have to rely on the general purpose bus for the reading. This structure contributes to a shorter processing time.

Furthermore, any technique may be used to detect the writing of the data in the relay resister 301, such as detecting via reception of a writing request from the MDIO master device 203.

In addition, another obtainment process may involve the following: the resister managing unit of the relay resister 301 causes the address in which the first CPU 202 has written the data to be stored in a storage medium other than the relay resister 301; and the second CPU 302 refers to the stored address.

For example, the resister managing unit in the relay resister 301 writes an address in a cash memory built in the second CPU 302. The address; namely the change address, is an address in which the first CPU 202 has written the data. Here, the second CPU 302 can read the change address at a high speed.

It is noted that information to be stored shall not be limited to the change address; instead, the information to be stored may be an address with the data written or storage data itself corresponding to the address.

Described next is another example of the first obtaining process.

For each regular interval, the second CPU 302 may read the data from the relay resister 301 and, depending on the result of the reading, carry out the first obtaining process. The regular interval according to the embodiment can be reset, such as 100 ms and 150 ms, depending on usage of the communication apparatus in the aspect of the present invention.

First, at a regular interval such as 100 ms, the second CPU 302 reads all data for each address included in the relay resister 301, and stores the data as read data. Next, the second CPU 302 determines whether or not a difference is found between the newest read data and read out data stored one step before. When the difference is found, the second CPU 302 specifies an address corresponding to a part including the difference as the change address. In other words, the second CPU 302 specifies the change address based on a difference found between twice-read data at a predetermined interval.

This operation can also detect writing of data in the relay resister 301, and specify a change address.

It is noted that the above process may involve storing a part of data stored in the relay resister 301.

Assume the following: the relay resister 301 includes Addresses “0” through “31”, and Addresses “10” through “21” are areas in which the second CPU 302 writes data.

Here, the second CPU 302 reads at a predetermined interval data assigned to “10” through “21” in the relay resister 301, and compares the data with data which is (i) assigned to the same areas, and (ii) was read one step before.

This allows the second CPU 302 to efficiently detect writing of data in the relay resister 301, and obtain a change address.

Instead of obtaining a change address out of a difference between (i) storage data of the relay resister 301 at a certain time and (ii) storage data in the past, the second CPU 302 may also obtain storage data associated with the change address. In other words, the second CPU 302 may obtain data itself indicating the difference.

As described above, the second CPU 302 obtains a change address or storage data associated with the change address. Then, the second CPU 302 reads a control program associated with the change address or to the storage data, and executes the read control program.

It is noted that the control program, which is executed by the second CPU 302 for obtaining the change address or the storage data, may also carry out control corresponding to the storage data. Here, when the second CPU 302 reads to execute the corresponding control, the second CPU 302 does not have to rely on the general purpose bus for the reading. This structure contributes to a shorter processing time.

Described next is an example of the second obtaining process.

Detailed is timing of the first CPU 202 executing the second obtaining process.

When the wireless PHY device 304 provides an interrupt acknowledgement to the second CPU 302, the second CPU 302 rewrites storage data included in the relay resister 301. Specifically, the second CPU 302 for example obtains details from the wireless PHY device 304 (linking-up and linking-down) of a condition change of the wireless PHY device 304. Then, the wireless PHY device 304 writes predetermined data in a predetermined address which is based on the obtained details.

When the second CPU 302 rewrites the relay resister 301, the relay resister 301 provides an interrupt acknowledgement to the first CPU 202. Then, the first CPU 202 executes the second obtaining process.

It is noted that the wireless PHY device 304 changes data stored in a resister included in the wireless PHY device 304 once the condition of the wireless PHY device 304 changes. Then, the wireless PHY device 304 provides the interrupt acknowledgement to the second CPU 302.

Furthermore, instead of receiving the interrupt acknowledgement from the wireless PHY device 304 to detect the condition change of the wireless PHY device 304, the second CPU 302 may detect a change of the storage data of the resister included in the wireless PHY device 304 so as to detect the condition change of the wireless PHY device 304.

For example, at a regular interval such as 100 ms, the second CPU 302 reads all data for each address included in the resister of the wireless PHY device 304, and stores the data as read data.

Next, the second CPU 302 determines whether or not a difference is found between the newest read data and read out data stored one step before. When a difference is found, the second CPU 302 writes for example predetermined data in a predetermined address included in the relay resister 301. Here, the predetermined address is based on either details of the difference or an address (i) included in the register and (ii) corresponding to the difference.

The above operation also allows the second CPU 302 to detect a condition change of the wireless PHY device 304.

Described next is the second obtaining process in detail.

Upon receiving the interrupt acknowledgement from the wireless PHY device 304, the second CPU 302 writes data in the relay resister 301 as described above. When the second CPU 302 writes the data in the relay resister 301, the relay resister 301 provides an interrupt acknowledgement to the first CPU 202.

Upon receiving the interrupt acknowledgement from the relay resister 301, the first CPU 202 obtains an address; namely a change address. The change address is included in the relay resister 301, and has the data written in by the second CPU 302.

It is noted that there may be another obtainment process: the resister managing unit of the relay resister 301 causes the address in which the second CPU 302 has written the data to be stored in a storage medium other than the relay resister 301; and the first CPU 202 refers to the stored address.

Moreover, the first CPU 202 may obtain storage data associated with the change address instead of obtaining the change address.

Described here is another example of the second obtaining process carried out by the first CPU 202.

For each regular interval, the first CPU 202 may read the data from the relay resister 301 and, depending on the result of the reading, carry out the second obtaining process. The regular interval according to the embodiment can be reset, such as 100 ms and 150 ms, depending on usage of the communication apparatus in the aspect of the present invention.

First, at a regular interval, such as 100 ms, the first CPU 202 reads all data for each address included in the relay resister 301, and stores the data as read data.

Next, the first CPU 202 determines whether or not a difference is found between the newest read data and read out data stored one step before. When the difference is found, the first CPU 202 specifies an address corresponding to a part including the difference. This operation can also detect writing of data in the relay resister 301, and specify a change address.

It is noted that the above process involves storing all the data for each address included in the relay resister 301; instead, the process may involve storing only a part of the data stored in the relay resister 301.

Instead of obtaining a change address out of a difference between (i) storage data of the relay resister 301 at a certain time and (ii) storage data in the past, the first CPU 202 may also obtain storage data associated with the change address. In other words, the first CPU 202 may obtain data itself indicating the difference.

Hence, the change address or the storage data associated with the change address both obtained by the first CPU 202 exemplifies the information corresponding to control used for the communication apparatus in the present invention. The first CPU 202 reads from the first nonvolatile recording medium 201 a control program associated either with the obtained change address or the obtained storage data, and executes the read control program.

It is noted that the control program which is executed by the first CPU 202 for obtaining either the change address or the storage data may also carry out control corresponding to the storage data. Here, when first CPU 202 reads to execute the corresponding control, the first CPU 202 does not have to rely on the general purpose bus for the reading. This structure contributes to a shorter processing time.

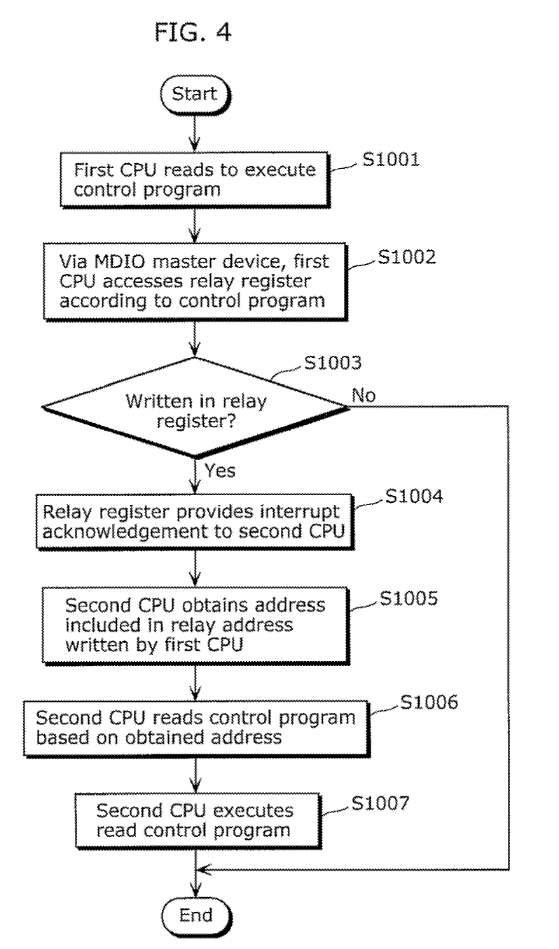

Described next is an operation of the communication apparatus 100 according to the embodiment in the present invention with reference to FIG. 4.

FIG. 4 is a flowchart showing a flow of a process in the communication apparatus 100 when the first CPU 202 controls wireless PHY device 304.

First, when a user operates the TV 1, the first CPU 202 reads a control program corresponding to the operation from first nonvolatile recording medium 201 via the general purpose bus, and executes the control program (S1001). Then, according to the executed program, the first CPU 202 controls and causes the MDIO master device 203 to write predetermined data in a predetermined address included in the relay resister 301 (S1002).

For example, the MDIO master device 203 writes data in the relay resister 301 for setting up an encryption key in the wireless PHY device 304. Here, the encryption key is employed for wireless communication.

In other words, a control, signal is provided from the master device 200 to the slave device 300. Accordingly, the data which is based on the control signal is written in the relay resister 301.

The relay resister 301 determines whether or not a memory image is written by the MDIO master device 203 (S1003). When the memory image is written (S1003: Yes), the operation proceeds to S1004. When the memory image is not written, the operation ends.

When the memory image is written in the relay resister 301, the relay resister 301 provides an interrupt acknowledgement to the second CPU 302 (S1004).

Upon receiving the interrupt acknowledgement from the relay resister 301, the second CPU 302 obtains the address; namely, a change address. The change address (I) has the data written in by the first CPU 202, and (ii) is included in the relay resister 301 (S1005).

The second CPU 302 reads from the second nonvolatile storage medium 303 a control program corresponding to the obtained storage data, and executes the read control program (S1006).

The second CPU 302 executes the read control program to control the wireless PHY device 304 (S1007). Then, the wireless PHY device 304 executes an operation defined by the control program.

The above process allows the master device 200 to cause the wireless PHY device 304 to execute an operation which is based on a control signal sent from the master device 200.

It is noted that, in S1005, the second CPU 302 obtains the change address included in the relay resister 301. The obtained shall not be limited to the change address; instead, obtained may be data written in the relay resister 301 via the control by the first CPU 202.

Here, the second CPU 302 reads a control program corresponding to the obtained data from the second nonvolatile storage medium 303, and executes the read control program. This also allows the master device 200 to cause the wireless PHY device 304 to execute an operation which is based on a control signal sent from the master device 200.

In the above description, the second CPU 302 reads the control program corresponding to the obtained change address, and executes the read control program (S1006 and S1007). Here, a program to be executed by the second CPU 302 for obtaining the change address (S1005) may include a control program corresponding to all the addresses, so that the second CPU 302 eliminates the need for reading the control program via the general purpose bus. Thus, this structure contributes to a shorter processing time when the second CPU 302 executes the control program.

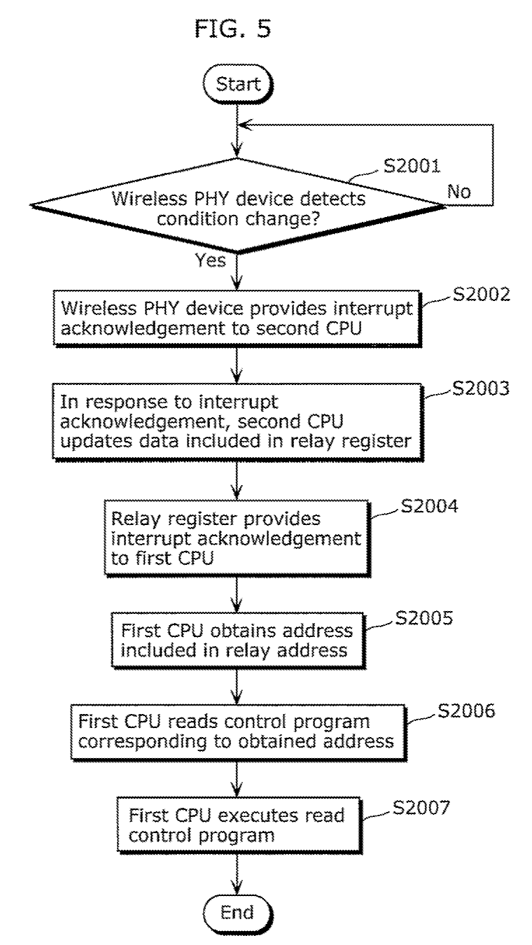

Described next is an operation of the communication apparatus 100 when a condition of the wireless PHY device 304 changes, with reference to FIG. 5.

FIG. 5 is a flowchart showing a flow of a process in the communication apparatus 100 when the first CPU 202 controls the master device 200 in response to the condition change of the wireless PHY device 304.

First, the wireless PHY device 304 checks whether or not a condition change is found therein (S2001). When a condition change is detected (S2001: Yes), the flow proceeds to S2002. When no condition change is detected (S2001: No), the wireless PHY device 304 repeats checking (S2001) whether or not a condition change is found.

When detecting a condition change, the wireless PHY device 304 provides an interrupt acknowledgement to the second CPU 302 (S2002).

Upon receiving the interrupt acknowledgement from the wireless PHY device 304, the second CPU 302 updates data included in the relay resister 301 in response to the received interrupt acknowledgement (S2003). In other words, the second CPU 302 writes predetermined data in a predetermined address which (i) corresponds to the interrupt acknowledgement, and (ii) is included in the relay resister 301.

Then, the relay resister 301 provides an interrupt acknowledgement to the first CPU 202 (S2004).

Upon receiving the interrupt acknowledgement from the relay resister 301, the second CPU 302 obtains an address; namely, a change address. The change address is updated by the first CPU 202, and included in the relay resister 301 (S2005).

The first CPU 202 reads from the first nonvolatile recording medium 201 a control program corresponding to the obtained change address (S2006).

The first CPU 202 executes the read control program (S2007). Then, the master device 200 executes a process to be defined by the control program.

The above process allows the master device 200 to execute the operation which is based on the condition change of the wireless PHY device 304.

It is noted that, in S2005, the first CPU 202 obtains the change address included in the relay resister 301. The obtained shall not be limited to the change address; instead, obtained may be data written in the relay resister 301 via the control by second CPU 302, as described above.

Here, the first CPU 202 reads from the first nonvolatile recording medium 201 a control program corresponding to the obtained data, and executes the read control program. The above process also allows the master device 200 to execute the operation which is based on the condition change of the wireless PHY device 304.

As described above, the communication apparatus 100 according to the embodiment causes the first CPU 202 included in the master device 200 to update, via the MDIO master device 203, the storage data of the relay resister 301 which is included in the slave device 300.

The second CPU 302 in the slave device 300 executes a control program based either on (i) a change address created by the update or (ii) storage data associated with the change address so as to control an operation of the wireless PHY device 304.

In the above structure, the relay resister 301 is installed in the slave device 300, so that the master device 200 can write the data in the relay resister 301. Thus, this structure allows the master device 200 to control the operation of the wireless PHY device 304 included in the slave device 300.

As a result, a control program to be executed by the communication apparatus 100 does not require much change. This makes possible curbing an increase in costs for developing the control program and malfunctions in the control program.

Furthermore, in the case where a condition change is found in the wireless PHY device 304, such as a field intensity change, the second CPU 302 included in the slave device 300 updates the storage data of the relay resister 301.

The first CPU 202 in the master device 200 executes a control program which is based either on (i) a change address created by the update or (ii) storage data associated with the change address.

The above process allows the master device 200 to execute an operation which is based on the condition change of the wireless PHY device 304.

Accordingly, consistency is ensured in the operations of the master device 200 and the slave device 300 even in the case where a condition change occurs in the wireless PHY device 304.

### Modification of Embodiment

In the embodiment, the slave device 300 uses the wireless PHY device 304 to get connected with an external network. However, the present invention shall not be limited to the structure: the present invention may also employ a wired PHY device to achieve the same effects.

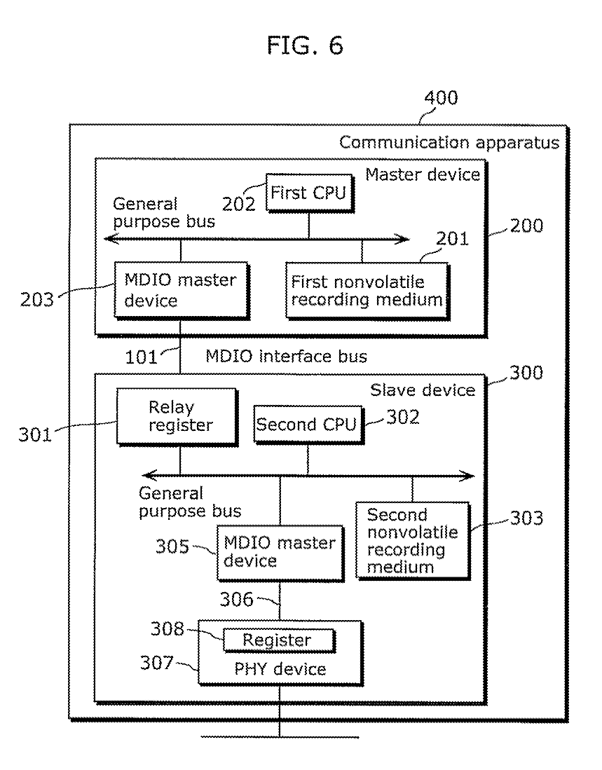

Instead of the wireless PHY device 304 included in the communication apparatus 100, a communication apparatus 400 shown in FIG. 6 has an MDIO master device 305 and a resister 308. The communication apparatus 400 includes a wired PHY device 307 capable of establishing a connection with a network via a wired LAN. The MDIO master device 305 and the wired PHY device 307 are connected via an MDIO interface bus 306.

It is noted that an address configuration of the resister 308 may be the same as that of the relay resister 301.

In this case, the wired PHY device 307 can be controlled according to IEEE802.3. This makes possible controlling the communication apparatus 400, eliminating the need for changing a program in a conventional communication device.

Hence, this structure is capable of achieving the following objects: communicating (i) at a communication speed required between the external apparatus and the local apparatus, such as communicating at 1 Gbps with an external apparatus (ii) by changing only the slave device 300 instead of changing hardware and software of the conventional communication device.

It is noted that the slave device 300 in the communication apparatus 400 may further include the wireless PHY device 304. Here, the master device 200 may selectively use, for example, the wired PHY device 307 or the wireless PHY device 304 as a PHY device to be used for having a connection with an external network.

In the above described embodiment and Modification of the embodiment, the master device 200 and the slave device 300 are connected via the MDIO interface bus 101. However, the connection shall not be limited to the above. Instead of the MDIO interface bus 101, used may be a general purpose bus including the following: a Personal Computer Memory Card International (PCMCIA), a Secure Digital Input/Output (SDIO), a Peripheral Component Interconnect (PCI), a mini PCI, and a PCI Express (PCIe).

In the above embodiment, the communication apparatus 100 is included in the TV 1. Concurrently, the communication apparatus 100 may be included in another kind of audio-visual appliance.

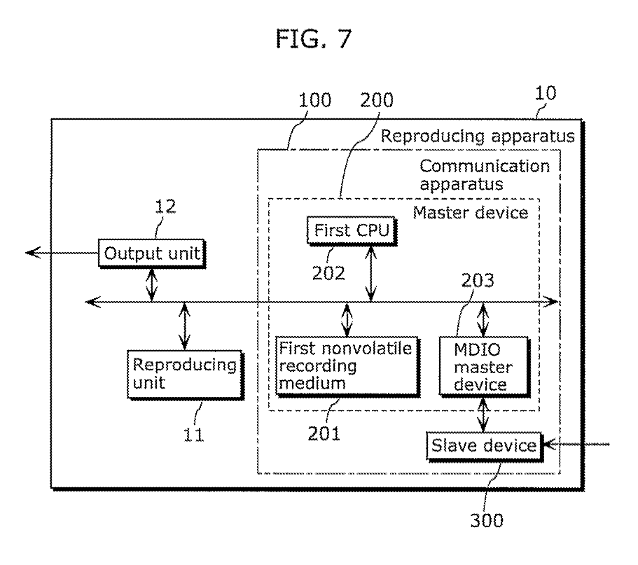

FIG. 7 is a schematic block diagram of a reproducing apparatus 10 exemplifying an audio-visual appliance including the communication apparatus 100 according to the embodiment in the present invention.

It is noted that the reproducing apparatus 10 can be the following: a BD player, a DVD player, and a Hard Disk Drive (HDD) recorder.

As shown in FIG. 7, the reproducing apparatus 10 includes the communication apparatus 100, a reproducing unit 11, and an output unit 12.

The reproducing unit 11 decodes image data received by the communication apparatus 100 via an external network. The output unit provides, to an external apparatus including a displaying apparatus, the decoded data sent from the reproducing unit 11.

Even though the communication apparatus 100 is installed in an audio-visual appliance including a BD player; namely the reproducing apparatus 10, the master device 200 still facilitates control on the PHY device included in the slave device 300 as so when the communication apparatus 100 is included in TV 1.

### INDUSTRIAL APPLICABILITY

The present invention allows a master device to control a communication unit included in a slave device, following an access sequence employed for a conventional slave device.

Thus, without a program change used in a conventional master device, a conventional communication apparatus can be equipped with, for example, a slave device having a wireless communication module. As a result, the present invention makes possible curbing an increase in costs for developing a program and reducing malfunctions in the program.

Hence, the present invention is useful for a broadcast receiving apparatus, such as a TV, as well as an audio-visual appliance including a BD player, a BD recorder, a DVD player, and a HDD recorder.

### REFERENCE SIGNS LIST

1 TV
2 Image processing unit
3 Displaying unit
10 Reproducing apparatus 10
11 Reproducing unit
12 Output unit
100 and 400 Communication apparatus
101 and 306 MDIO interface bus
200 Master device
201 First nonvolatile recording medium
202 First CPU
203 and 305 MDIO master device
300 Slave device
301 Relay resister
302 Second CPU
303 Second nonvolatile recording medium
304 Wireless PHY device
307 Wired PHY device
308 Resister

1. A communication apparatus including a master device and a slave device which receives a control signal provided from the master device,
wherein the slave device comprises:
a slave control unit configured to control the slave device;
a relay register in which data is written according to the control signal;
a data communication unit configured to establish a connection with an external data communication channel; and
a slave storage unit configured to store a control program controlling an operation of said data communication unit,
said slave control unit is configured to control said data communication unit by (i) obtaining information corresponding to control, (ii) reading from said slave storage unit a control program which is associated with the obtained information corresponding to control, and (iii) executing the read control program, the information corresponding to control being information on the writing of the data in said relay register according to the control signal, and
the master device comprises:
a master control unit configured to control the master device; and
a master storage unit configured to store a control program controlling the master device,
when detecting a condition change of said data communication unit, said slave control unit is configured to write data in said relay register depending on details of the detected condition change, and
said master control unit is configured to control the master device by (i) obtaining information corresponding to a change, (ii) reading from said master storage unit a control program which is associated with the obtained information corresponding to a change, and (iii) executing the read control program, the information corresponding to a change being information on the writing of the data in said relay register of the data by said slave control unit.

2. (canceled)

3. The communication apparatus according to claim 1,
wherein the master device and the slave device are connected via an IEEE 802.3-defined Management Data Input/Output (MDIO) interface.

4. The communication apparatus according to claim 1,
wherein said slave control unit is configured to (i) obtain a change address as the information corresponding to control, the change address being an address included in said relay register in which the data is written according to the control signal, (ii) read the control program associated with the change address from said slave storage unit, and (iii) execute the read control program.

5. The communication apparatus according to claim 4,
wherein said slave control unit is configured to obtain the change address by (i) reading the data stored in said relay register twice at a predetermined interval, and, in the case where a difference is found between the twice-read data, (ii) specifying an address corresponding to the difference as the change address.

6. The communication apparatus according to claim 5,
wherein said slave control unit is configured to read the data twice only from a designated area included in said relay register.

7. A method for controlling communication on a communication apparatus including a master device and a slave device which receives a control signal provided from the master device, the slave device including a slave control unit which controls the slave device, a data communication unit which establishes a connection with an external data communication channel, and a slave storage unit which stores a control program to be used for controlling an operation of the data communication unit, and said method comprising:
first writing of data in a relay register according to the control signal;
first obtaining, by the slave control unit, information corresponding to control which is information on said first writing according to the control signal; and
controlling the data communication unit by causing the slave control unit to (i) read from the slave storage unit a control program which is associated with the obtained information corresponding to control, and (ii) execute the read control program
wherein the master device includes: a master control unit which controls the master device; and a master storage unit which stores a control program controlling the master device, and
said method for controlling communication further comprises:
second writing of data in the relay register performed by the slave control unit depending on details of a condition change when the slave control unit detects the condition change of the data communication unit;
second obtaining, by the master control unit, information corresponding to a change on said second writing data in the relay register performed by the slave control unit in said second writing; and
controlling the master device by causing the master controlling unit to (i) read from the master storage unit a control program which is associated with the obtained information corresponding to a change, and (ii) execute the read control program.

8. (canceled)

9. A broadcast receiving apparatus which establishes a connection with a network, said broadcast receiving apparatus comprising:
the communication apparatus according to claim 1;
an image processing unit configured to decode image data obtained from the communication apparatus; and
a displaying unit configured to display the decoded image data obtained from said image processing unit.

10. A reproducing apparatus which establishes a connection with a network, said reproducing apparatus comprising:
the communication apparatus according to claim 1;
a reproducing unit configured to decode image data obtained from the communication apparatus; and
an outputting unit configured to output the decoded image data obtained from said reproducing unit.
